(19) United States
(12) Patent Application Publication
(10) Pub. No.: US 2024/0341314 A1
(43) Pub. Date: Oct. 17, 2024

(54) SET FOR FORMING THREE-DIMENSIONAL STRUCTURES

(71) Applicant: Clarissa CABAUATAN, Wien (AT)

(72) Inventor: Clarissa CABAUATAN, Wien (AT)

(21) Appl. No.: 18/292,132

(22) PCT Filed: Jul. 14, 2022
(86) PCT No.: PCT/EP2022/069733

§ 371 Date: Jan. 25, 2024

(30) Foreign Application Priority Data
Aug. 17, 2021 (AT) A 50665/2021

(51) Int. Cl. A21C 11/10; A21B 3/13; A23P 30/10; B44C 3/08

(52) U.S. Cl. CPC A21C 11/106; A21B 3/132; A23P 30/10; B44C 3/082

(57) ABSTRACT

A set includes at least two means for creating essentially two-dimensional shaped pieces from an essentially flat plastic material, whereas the plastic material hardens or can be hardened and whereas the means have different shapes and/or sizes, and at least one mould for moulding essentially two-dimensional shaped pieces into a three-dimensional sculpture.

The invention concerns a set including at least two means for creating essentially two-dimensional shaped pieces from an essentially flat plastic material.

Cookies are traditionally flat and are shaped in different designs. Additional patterns such as lines, indentions or holes are included to add more details and make the cookies more aesthetically looking. Nowadays, methods to make cookies looking realistically by making them three-dimensional (3D) are created. Examples of these methods are putting flat stackable baked cookie pieces to make the cookies elevated, interconnecting cookie pieces with complementary slots after baking to support each piece and make it stand (examples for this technique are shown in U.S. Pat. No. 2,876,714 A or US 2004/142063 A1), putting predetermined cut dough onto 3D forms (an example is shown in U.S. Pat. No. 5,437,829A) or cutting flat pieces of cookies that are glued together after baking (an example is the usual way of making ginger bread houses). These methods, however, produce cookies that still show the rigidity or flatness of the dough sheets.

Because flat cookie pieces are simply put together after baking, the cookies appear as a discontinuous design which does not show unity.

The objective of the invention is to overcome this disadvantage and to provide a set of tools and a method to create three-dimensional cookies that are solid, robust and unified in structure.

This objective is solved with a set according to claim 1 and a method according to claim 14.

According to the invention a set includes at least two means for creating essentially two-dimensional shaped pieces from an essentially flat plastic material, whereas the plastic material hardens or can be hardened and whereas the cutters have a different shape and/or size, and at least one mould for moulding essentially two-dimensional shaped pieces into a three-dimensional sculpture. That way optically appealing three-dimensional structures, especially cookies, can be created.

According to a preferred embodiment of the invention the means for creating essentially two-dimensional shaped pieces are cutters. Of course, it is possible to provide just patterns according to which the shaped pieces are to be created, for example by cutting along the patterns with a knife, but cutters are more comfortable to use and can provide a certain uniformity and precision when creating the shaped pieces.

According to a preferred embodiment of the invention the cutters are made of a material or a combination of materials from the list containing: plastic, silicone and/or metal. That way the cutters a durable and easy to clean.

According to a further preferred embodiment of the invention at least one of the means for creating essentially two-dimensional shaped pieces is shaped to create a protrusion in one of the shaped pieces, at least one of the means for creating essentially two-dimensional shaped pieces is shaped to create a notch in one of the shaped pieces, and the created protrusion and notch are essentially interlocking in an assembled state of the three-dimensional sculpture. This has two advantages. One advantage is that the resulting three-dimensional sculpture has more stability. The other advantage is, that the sculpture cannot be assembled wrongly as there is a clear indication on how to position the interlocking parts of the shaped pieces relative to each other. This makes the set easier to use, especially for younger users or users that are otherwise impaired.

According to another preferred embodiment of the invention the mould or the moulds is/are made from a heat resistant material. If the hardening of the plastic material requires the application of heat, for example baking dough, the mould can resist this process.

According to another preferred embodiment of the invention the mould or the moulds has/have a contact surface for receiving the shaped pieces. That way even an unexperienced user can mould the shaped pieces against the mould.

According to another preferred embodiment of the invention the mould or the moulds has/have at least one bordering surface, especially several bordering surfaces, bordering at least part of the contact surface. According to a further development of this embodiment the extension of the at least one bordering surface corresponds to the extension of at least one edge of the shaped piece/pieces. This helps with better positioning of the shaped pieces on the moulds. It also avoids that the shaped pieces deform while being hardened to a degree where assembly of the pieces would be difficult. The latter can especially happen when working with materials like dough that often increase their volume when being hardened by baking. Especially in case that the edges deform due to baking and differ from a predefined extension, there is the risk that pieces supposed to be interlocking do not fit any more. Thus, this embodiment has the special advantage to ensure that hardened pieces actually show the intended form.

According to another preferred embodiment of the invention the contact surface is shaped essentially conical or prismatically with a square or triangle base. These shapes have proven to be especially useful for creating optically pleasing three-dimensional structures.

According to another preferred embodiment of the invention the contact surface of the mould(s) has holes or channels. This helps to better distribute heat to the inside of the moulded shaped pieces and assists even hardening.

According to another preferred embodiment of the invention the mould or the moulds is/are coated, especially coated with a non-stick material, for example polytetrafluoroethylene. That way the three-dimensional sculptures can be removed easily from the moulds.

Overall, the invention can create three-dimensional cookies that are more realistically looking than the prior art while still using the traditional flat dough sheets.

Further preferred and advantageous embodiments of the invention are object of the dependent claims.

In the following a depiction of a preferred embodiment of the invention is described. The described embodiments are solely meant to exemplify the invention, which is not limited to the shown examples but may be implemented in a wide range of embodiments. Similar parts on different embodiments have the same reference numerals for the sake of better overview.

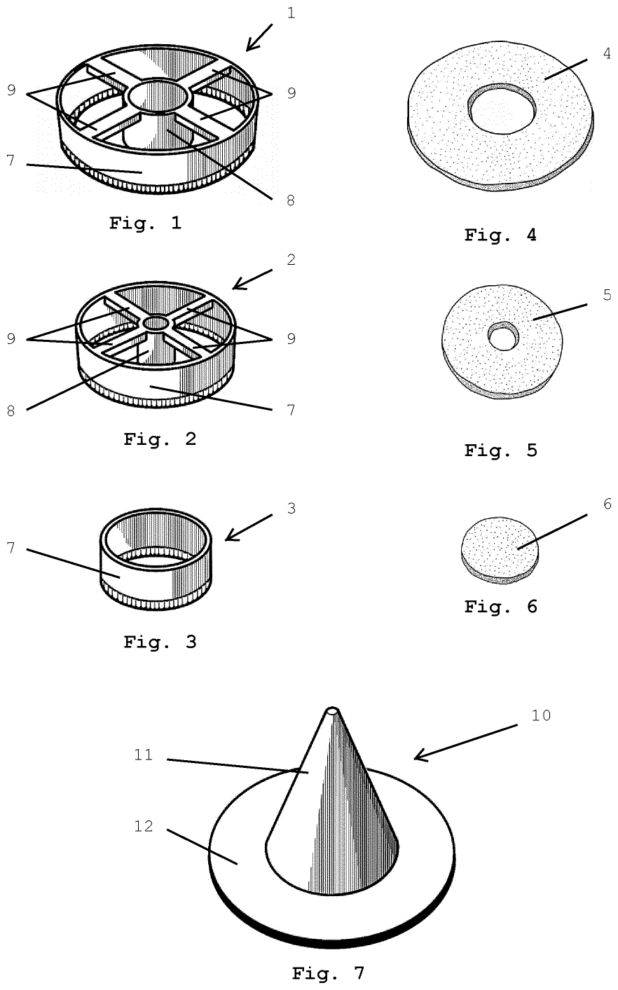

FIGS. 1 to 3 cutters of a first set,

FIGS. 4 to 6 shaped pieces created by the cutters of the first set,

FIG. 7 a mould for moulding the shaped pieces of FIG. 4 to FIG. 6 created by the cutters of the first set of FIGS. 1 to 3,

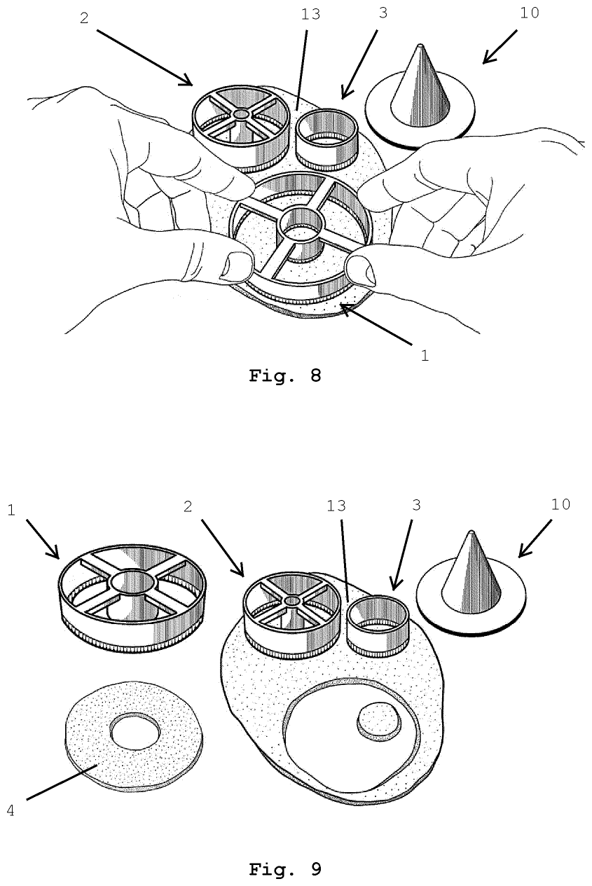

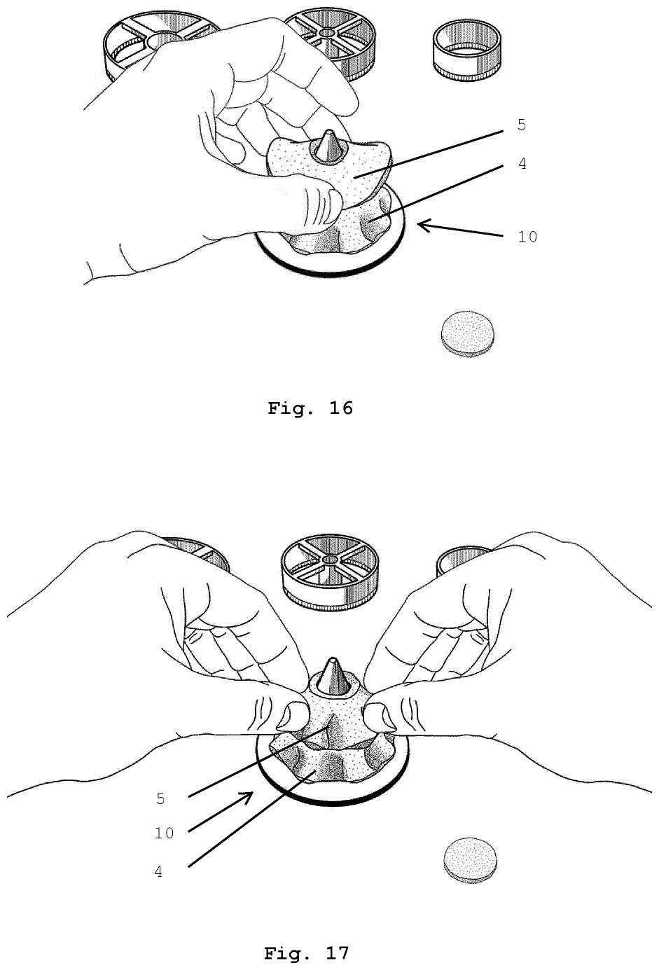

FIGS. 8 to 19 exemplary steps of a first method carried out with the first set shown in FIGS. 1 to 3 and 7,

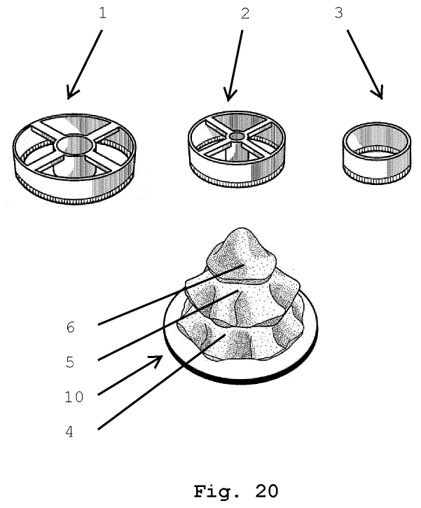

FIG. 20 a three-dimensional sculpture created according to the method of FIGS. 8 to 19 with the elements of FIGS. 1 to 7,

FIGS. 21 to 22 two moulds of a second set,

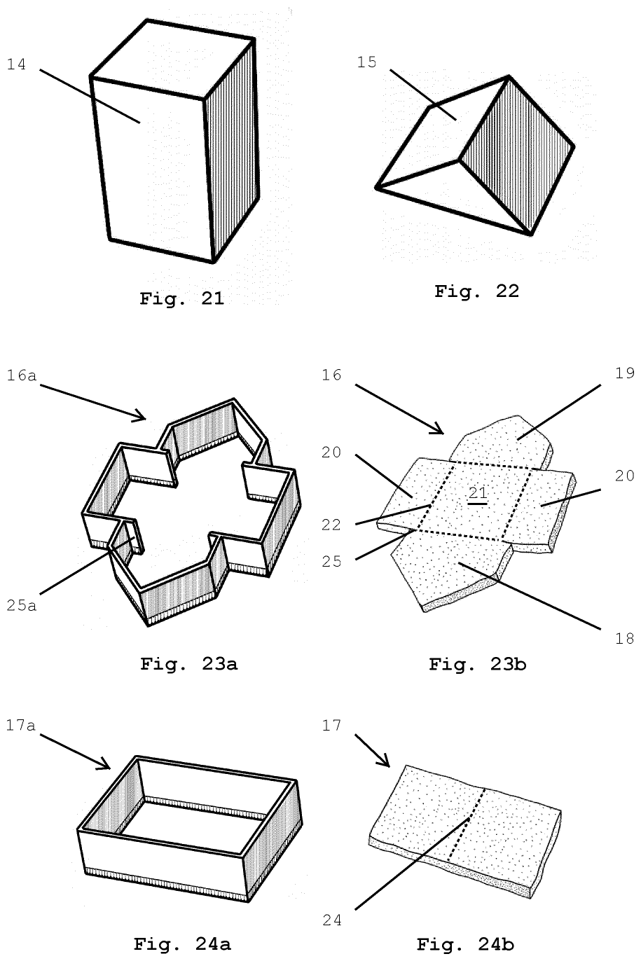

FIGS. 23a to 24b cutters of a second set and shaped pieces created by said cutters,

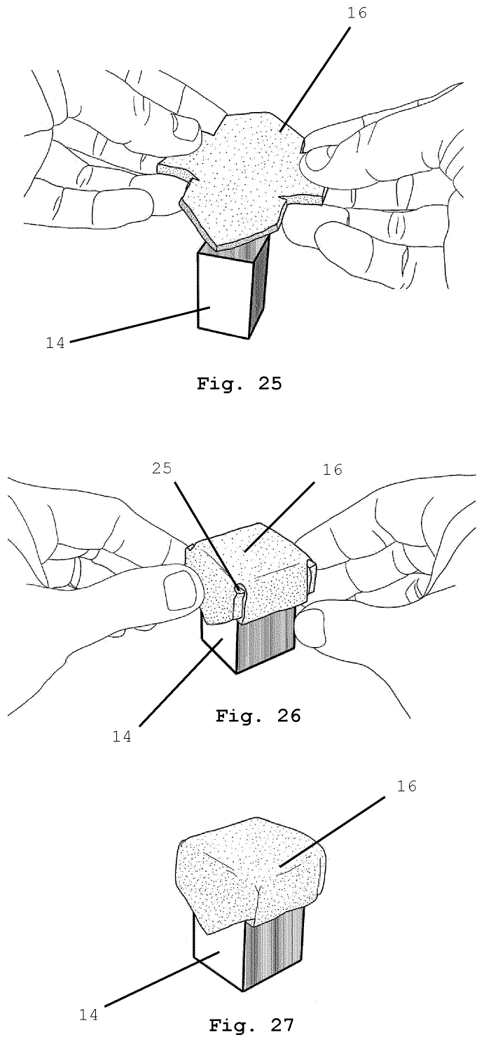

FIGS. 25 to 30 exemplary steps of a second method carried out with the second set shown in the FIGS. 21 to 24,

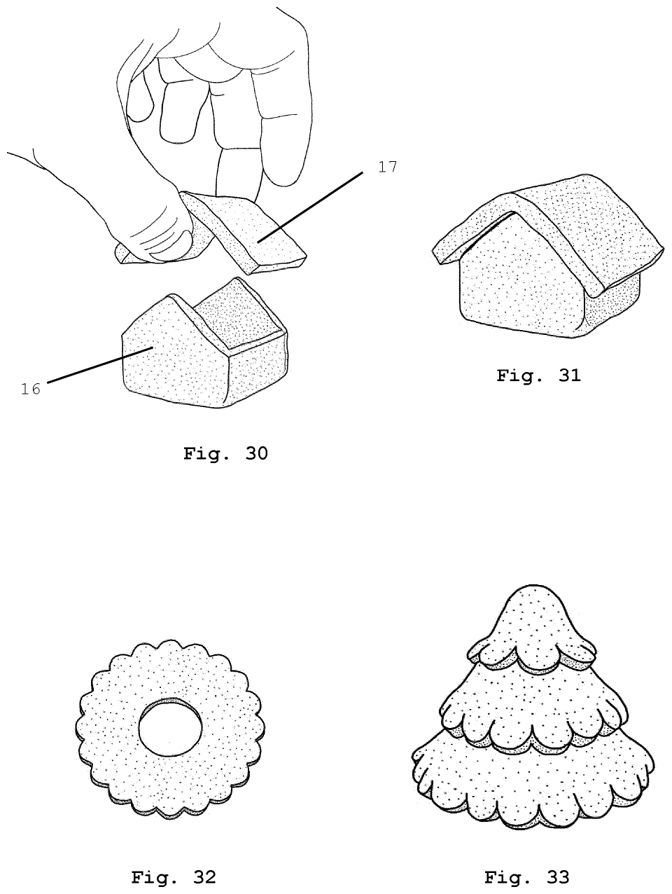

FIG. 31 a three-dimensional sculpture created according to the method of FIGS. 25 to 30 with the elements of FIGS. 21 to 24,

FIG. 32 an exemplary form of a shape of the first set,

FIG. 33 a three-dimensional sculpture created with alternate cutters according to FIG. 32 and the method according to FIGS. 8 to 19,

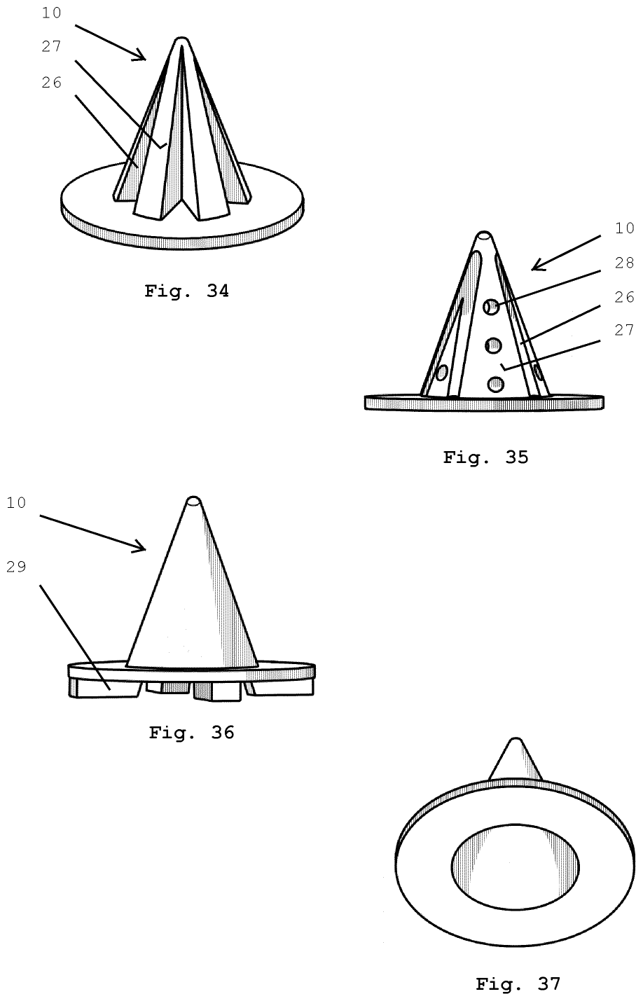

FIG. 34 a first alternative embodiment of the mould shown in FIG. 7,

FIG. 35 a second alternative embodiment of the mould shown in FIG. 7,

FIG. 36 a third alternative embodiment of the mould shown in FIG. 7,

FIG. 37 a view of the mould shown in FIG. 7 from below,

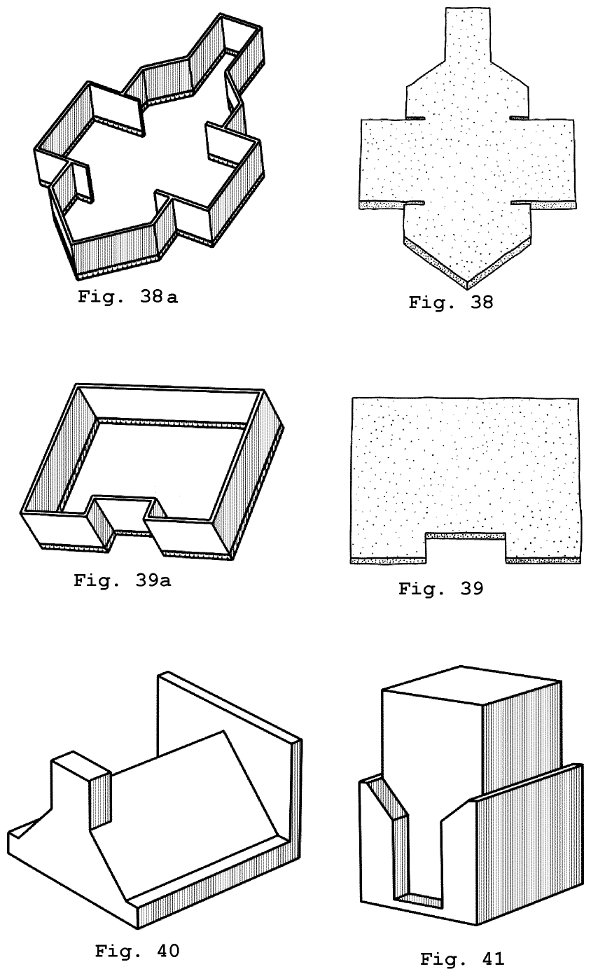

FIGS. 38a to 39 an alternative embodiment of the second set of cutters and shaped pieces created by said cutters,

FIGS. 40 to 41 an alternative embodiment of the second set of moulds,

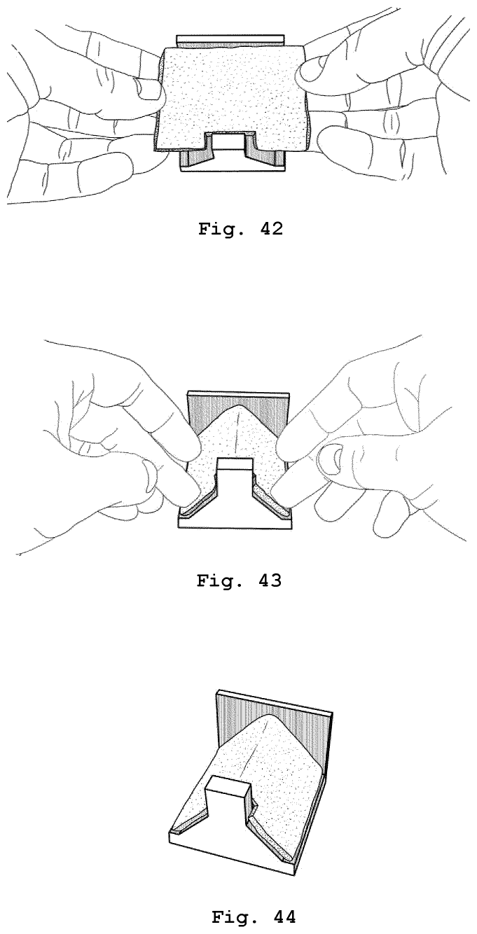

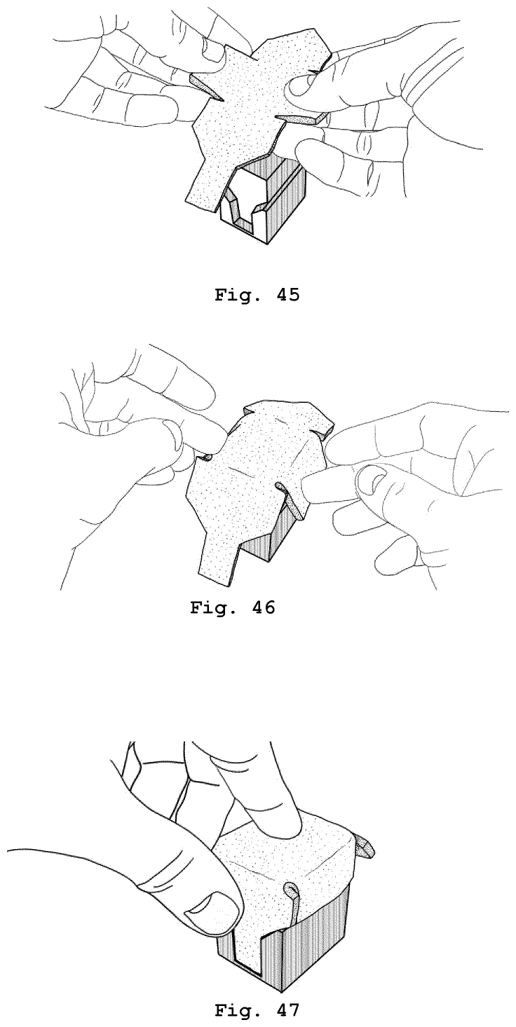

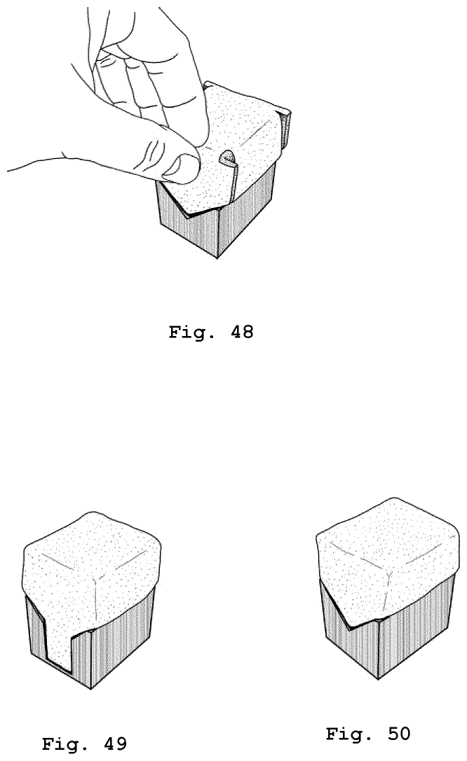

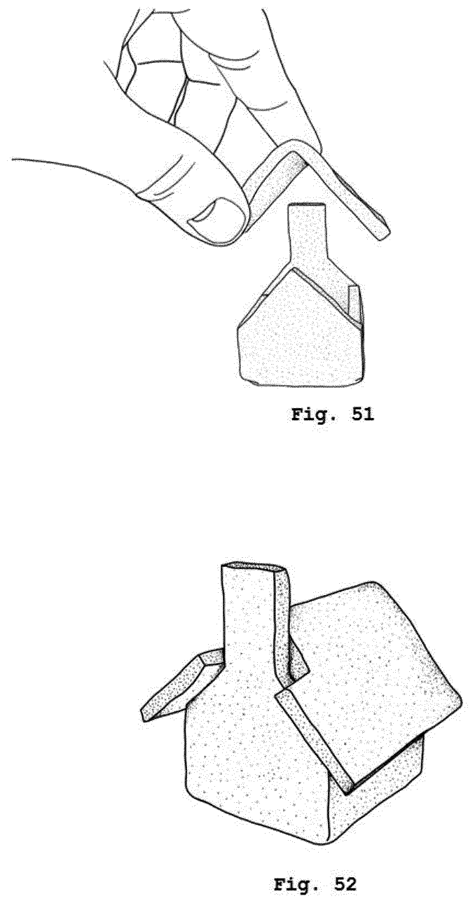

FIGS. 42 to 51 exemplary steps of the alternative embodiment of the second method carried out with the alternative embodiment of the second set and

FIG. 52 a three-dimensional sculpture created according to the method of FIGS. 42 to 51 with the elements of FIGS. 38 to 41.

The FIGS. 1 to 20 show the devices and steps of a method according to a first implementation of the invention, that will create a first, essentially Christmas tree shaped, three-dimensional sculpture.

To create the first sculpture, three differently sized cutters 1, 2, 3 (see FIGS. 1 to 3) are used. The shaped pieces 4, 5, 6 created by these cutters are shown in FIGS. 4 to 6. The shaped pieces 4, 5, 6 will later, when layered upon each other, create the first sculpture. The two shaped pieces 4, 5 that will constitute lower layers, are essentially ring shaped. The shaped piece 6 that will constitute the top layer has a simple round shape.

The cutters 1, 2, 3 have a thin vertically oriented periphery, which for example may be made up of metal or plastic. For patterns which consists 2 parts (e.g., the outer and inner rings 7, 8 for the hole in the bottom and middle layers). Holder structures 9 are holding the inner and outer rings 7,8 together.

FIG. 7 shows a first mould 10 that consists of a 3D cone structure 11 and a base 12.

FIG. 8 shows a first step in an exemplary first method to create a three-dimensional sculpture. In said first step the cutters 1, 2, 3 are placed on an essentially two-dimensional sheet of plastic material, in the case of this exemplary method this is rolled out dough 13. However other materials are also conceivable for the essentially two-dimensional sheet of plastic material and may be picked from a list that contains but is not limited to: polymer clay, conventional clay, concrete, play dough, UV reactive polymers or (cookie) dough.

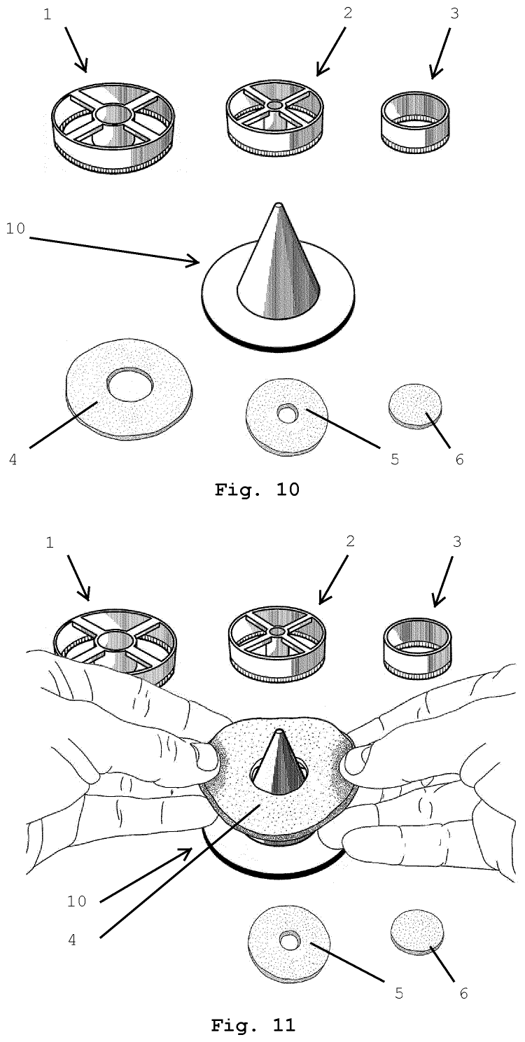

In a second step (FIGS. 9 and 10) the cutters 1, 2, 3 are used to cut shaped pieces 4, 5, 6.

In a third step (FIG. 11) the largest shaped piece 4 is placed upon the mould 10 such that the cone structure 11 peak through the hole in the ring-shaped shaped piece 4.

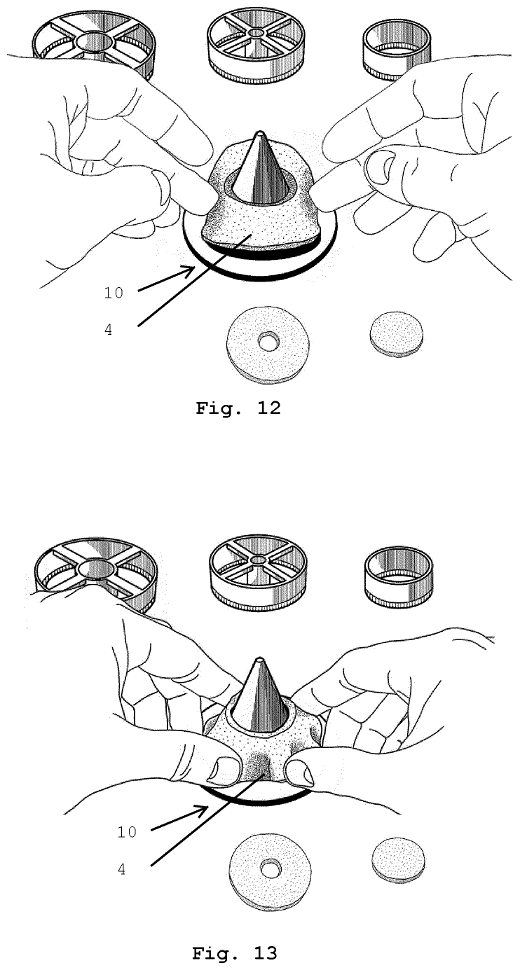

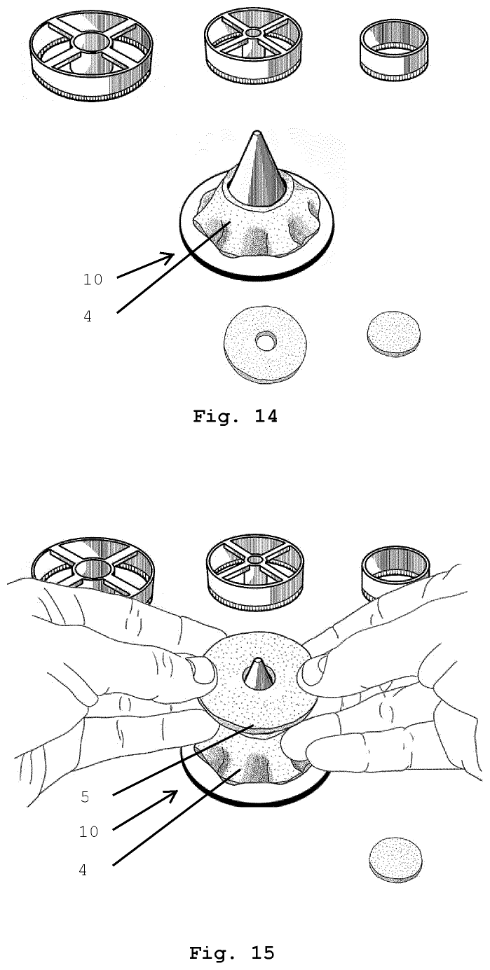

As seen in FIGS. 12 and 13 the shaped piece 4 is then moulded against the mould 10 in a following fourth step. FIG. 14 shows the result of said fourth step.

In a fifth step the medium sized shaped piece 5 is placed upon the mould 10 and in a sixth step moulded against the mould 10 as can be seen in FIGS. 15 to 17.

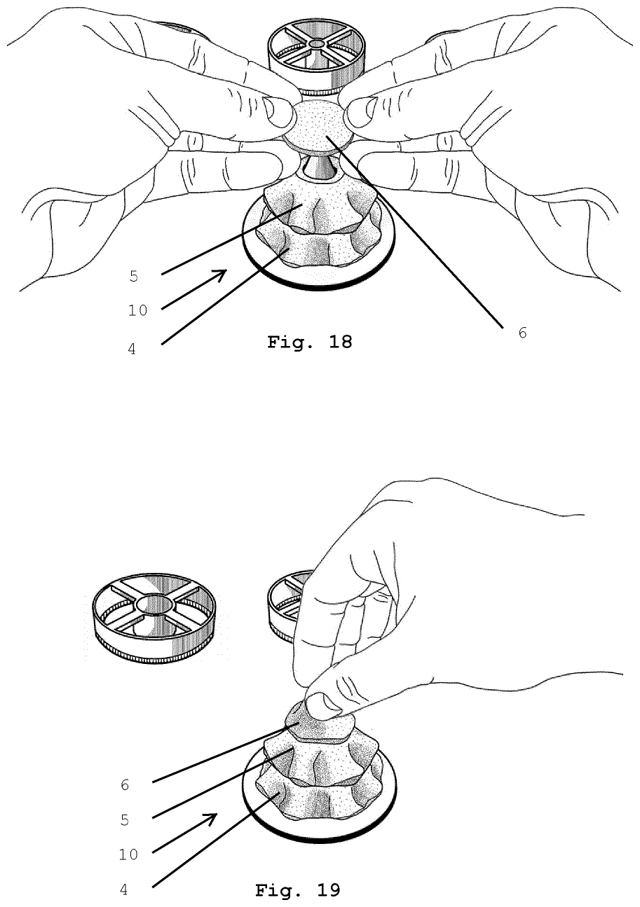

In a seventh step the smallest piece is placed on top of the mould (see FIG. 18) and moulded against the mould in a subsequent eighth step (see FIG. 19).

FIG. 20 shows the result of the previous steps.

In an optional step (not shown) the dough is then hardened, in this case by baking it in an oven. If material is used that hardens on its own, like concrete for example, that step is not necessary to be carried out.

In a final step (not shown) the now hardened sculpture is removed from the mould and can be used for further purposed or be decorated, for example in the case of a sculpture made with cookie dough it can be decorated with green sugar glazing and sugar pearls.

The FIGS. 21 to 31 show the devices and steps of a method according to a second implementation of the invention, that will create a second, essentially house shaped, three-dimensional sculpture.

FIGS. 21 and 22 show a set of two second moulds 14, 15, with shapes that are geometric prism, whereas the first of the second moulds 14 has a square base, the second of the second moulds 15, has a triangular base. The roughly correspond to the shapes of a body (see mould 14) and a roof (see mould 15) of a house.

FIGS. 23b and 24b show shaped pieces 16, 17 that are made by a corresponding second set of cutters 16a, 17a (shown in FIGS. 23a and 24a). The shaped piece 16 that can be used to create a house's body, has several sections that correspond to different part of the house shape, like front and back walls 18, 19, side walls 20 and a floor 21. The different sections are separated by dotted lines 22. Along these lines the dough will fold when placed (see FIGS. 25 and 26) on the corresponding mould 14 (see FIG. 21).

To facilitate easier folding the cutters may have additional non-cutting protrusions that make dents in the dough without cutting it.

Analogously the shaped piece 17 that can be used to create the shape of a roof shows a dotted line 23 where the roof folds up to create a ridge.

FIG. 25 shows the shaped piece 16 that can be used to create a house's body, being placed over the corresponding mould 14. When folded down the sides of the mould 14, a small surplus 25 (see FIG. 23) on the front and back walls 18, 19 compensates for the thickness of the dough. In FIG. 26 the corners are then pressed together to form an essentially continuous outer wall as can be seen in FIG. 27.

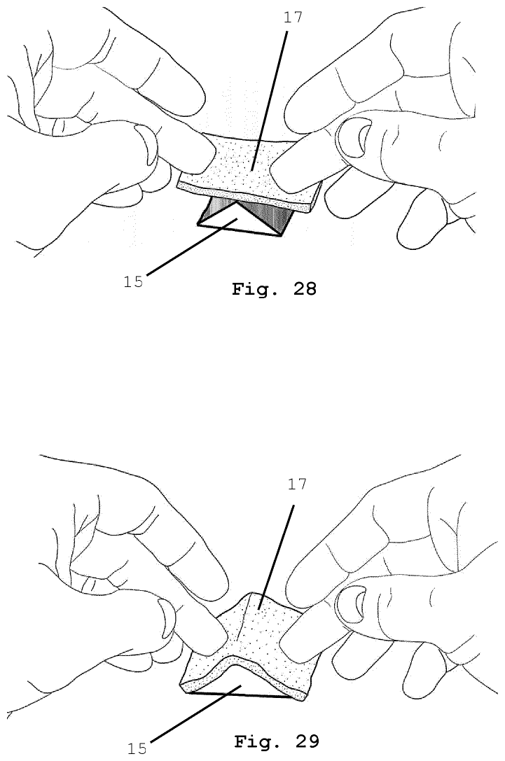

FIG. 28 shows the shaped piece 17 that can be used to create the shape of a roof being placed on the other triangular mould 15. Then the shaped piece 17 is moulded against the mould in FIG. 29.

Then the shaped pieces are hardened (not shown). In the case of dough this can for example be baking. Depending on the chosen materials the process of hardening the shaped pieces can happen by itself over time (for example, if a concrete mass is used).

After hardening the two shaped pieces are removed from the moulds and assembled as can be seen in FIG. 30. The assembly may be supported by using adhesive substances. In the case of cookie dough sugar icing or melted chocolate are possible glues.

FIG. 31 shows the completed, house shaped, three-dimensional sculpture.

FIG. 32 shows an alternative form of a shaped piece created with a cutter like described for the first application of the invention. This alternate shape has corrugated outer rim and creates an aesthetically slightly different three-dimensional sculpture, as can be seen in FIG. 33.

FIGS. 34 to 35 shown alternative embodiments of the mould shown in FIG. 7.

The first alternative embodiment shown in FIG. 34 shows channels 26 in a contact surface 27 on which the shaped pieces 4, 5, 6 can be placed during hardening. These channels 26, can provide better air circulation when heat is used for hardening.

The second alternative embodiment as shown in FIG. 35 shows next to the channels 26 in the contact surface 27 also holes 28. This measurement also increases heat circulation.

Another improvement for the heat circulation is shown in FIG. 36 where the mould 10 has feet 29.

As can be seen in FIG. 37 the mould is preferably hollow. This saves material for the creation of the mould and also enhances an even distribution of heat.

FIGS. 38a to 51 show sets and a method analogous to the sets and method shown in FIGS. 21 to 31. While the method is essentially the same, the shaped pieces in this embodiment are asymmetrical. This has essentially three advantages. The first advantage is that the sculpture can no longer be assembled wrongly. The same is valid for the placement of the shaped pieces on the moulds. This prevents user error as it may especially occur with very young users. The third advantage is that the asymmetrical form gives the resulting sculpture the appearance of having a chimney, which is aesthetically pleasing.

A sculpture created with these alternative second sets and method is shown in FIG. 52.

1. Set including at least two cutters configured to create essentially two-dimensional shaped pieces with a base surface from an essentially flat plastic material, whereas the plastic material hardens or can be hardened and whereas the cutters have different shapes and/or sizes, and at least one mould for moulding essentially two-dimensional shaped pieces into a three-dimensional sculpture.

2. (canceled)

3. Set according to claim 1, wherein the cutters are made of a material or a combination of materials chosen from the list containing: plastic, silicone and/or metal.

4. Set according to claim 1, wherein at least one of the cutters is shaped to create a protrusion in one of the shaped pieces, in that at least one of the cutters is shaped to create a notch in one of the shaped pieces, and in that the created protrusion and notch are essentially interlocking in an assembled state of the three-dimensional sculpture.

5. Set according to claim 1, wherein the mould or the moulds is/are made from a heat resistant material.

6. Set according to claim 1, wherein the mould or the moulds has/have a contact surface for receiving at least a part of the base surface of the shaped piece/pieces.

7. Set according to claim 6, wherein the contact surface is shaped essentially conical or prismatically with a square or triangle base.

8. Set according to claim 6, wherein the contact surface has holes or channels.

9. Set according to claim 1, wherein the mould or the moulds has/have at least one bordering surface, especially several bordering surfaces, bordering at least part of the contact surface.

10. Set according to claim 9, wherein the extension of at least one bordering surface corresponds to the extension of at least one edge of the shaped piece/pieces.

11. Set according to claim 1, wherein the cutters have an outer and an inner ring/part/pattern that are connected with holder structures.

12. Set according to claim 1, wherein cutting edges of the cutters are corrugated.

13. Set according to claim 1, wherein the mould or the moulds is/are coated, especially coated with a non-stick material, for example polytetrafluoroethylene.

14. Method for creating a three-dimensional sculpture, wherein at least two essentially two-dimensional shaped pieces are cut from plastic material that can be hardened and wherein the essentially two-dimensional shaped pieces are moulded over a mould and hardened on the mould.

15. Method according to claim 14, wherein the plastic material is dough and that the hardening is baking.

16. Method according to claim 15, wherein the plastic material is polymer clay or clay and that the hardening is the application of heat to the material.

17. Method according to claim 15, wherein the material is concrete or epoxy modelling clay and that the hardening happens with the passing of time.

18. Method according to claim 14, wherein the moulded shaped pieces are stacked together on the mould before hardening.

19. Method according to claim 14, characterized in that wherein the shaped pieces are stacked together after hardening.

20. Set including at least two means for creating essentially two-dimensional shaped pieces with a base surface from an essentially flat plastic material, whereas the plastic material hardens or can be hardened and whereas the means have different shapes and/or sizes, and at least one mould for moulding essentially two-dimensional shaped pieces into a three-dimensional sculpture.
